(19) United States
(12) Patent Application Publication
(10) Pub. No.: US 2006/0266934 A1
(43) Pub. Date: Nov. 30, 2006

(54) Optical navigation method and apparatus

(76) Inventors: Bernard Chan Lye Hock, Penang (MY); Shan Chong Tan, Selangor (MY); Tong Sen Liew, Perak (MY)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/140,281

(22) Filed: May 27, 2005

(51) Int. Cl. G06M 7/00

(52) U.S. Cl. 250/221

(57) ABSTRACT

The invention provides a method and apparatus for performing optical navigation. The optical navigation apparatus comprises a first light source, a second light source, an optical sensor that converts light into electrical signals, and processing logic. The processing logic is configured to process the electrical signals output by the optical detector to obtain information relating to motion or an absence of motion of the optical navigation apparatus. Based on the motion information obtained, the processing logic turns on the first light source and turns off the second light source, or vice versa. This ensures that, regardless of the tracking surface, the optical navigation apparatus will be using a light source that enables the optical navigation apparatus to operate effectively.

### BACKGROUND OF THE INVENTION

An optical mouse is an optical navigation apparatus that is used as a pointing device in computer systems. A typical optical mouse has an optical sensor, a light source for illuminating a surface, a lens for focusing light reflected from the surface onto the optical sensor, and a processor that processes the output of the optical sensor. As the optical mouse is moved relative to the surface, the optical sensor acquires a series of images of the surface, which are processed by the processor. The processor determines the position of the optical mouse relative to the surface by comparing the differences between consecutive images, i.e., the magnitude of movement changes and the direction of the changes between the images.

The illumination intensity of the light focused by the lens onto the optical sensor should be uniform so that the acquired image accurately represents the surface. In addition, the illumination beam should be as compact as possible. Some optical mice use light emitting diodes (LEDs) as light sources. LEDs provide generally uniform illumination intensity, but the beams are not very compact, i.e., they tend to be divergent and diffuse. Using LEDs has presented contrast problems in cases where the surface being illuminated by the optical mouse is glossy.

Recently, there has been a move towards using vertical cavity surface-emitting laser (VCSEL) diodes as light sources in optical mice. Optical mice that use VCSEL diodes have superior navigation capabilities over those that use LEDs in cases where the surface being illuminated is of low contrast. VCSEL diodes produce a beam that has very uniform illumination intensity and low divergence. These are characteristics that improve the contrast of the surface images and therefore enhance navigation capabilities.

It has recently been discovered that, on some tracking surfaces, optical mice that use LEDs have superior navigation capabilities over those that use VCSEL diodes, such as on frosted glass surfaces, for example. Therefore, while optical mice that use VCSEL diodes operate well on some types of surfaces, they do not operate well on all types of surfaces. Likewise, while optical mice that use LEDs operate well on some types of surfaces, they do not operate well on all types of surfaces.

A need exists for an optical navigation apparatus that is capable of performing well on many different types of tracking surfaces.

### SUMMARY OF THE INVENTION

The invention provides a method and apparatus for performing optical navigation. The optical navigation apparatus comprises a first light source, a second light source, an optical sensor that converts light into electrical signals, and processing logic. The processing logic is configured to process the electrical signals to obtain information relating to motion or an absence of motion of the optical navigation apparatus and to turn on and off the first and second light sources based on the information relating to motion or an absence of motion.

The method comprises turning on a first light source, determining whether or not any motion of the optical navigation apparatus has been detected by an optical sensor, if a determination is made that no motion has been detected, turning off the first light source and turning on a second light source.

Thus, the invention provides for using multiple light sources in an optical navigation apparatus and for switching from using one of the light sources to using another of the light sources when motion information indicates that no motion has been detected. This ensures that, regardless of the tracking surface, the optical navigation apparatus will be using a light source that enables the optical navigation apparatus to operate effectively.

These and other features and advantages of the invention will become apparent from the following description, drawings and claims.

### BRIEF DESCRIPTION OF THE DRAWINGS

FIG. 1 illustrates a block diagram of the electrical and optical components of the optical navigation apparatus of the invention in accordance with an embodiment.

FIG. 2 illustrates a block diagram of the components of the processor 40 shown in FIG. 1.

FIG. 3 illustrates a flowchart demonstrating the method of the invention in accordance with an embodiment.

FIG. 4 illustrates a flowchart demonstrating the method of the invention in accordance with another embodiment, which is a modification to the embodiment represented by the flowchart shown in FIG. 3.

### DETAILED DESCRIPTION OF AN EXEMPLARY EMBODIMENT

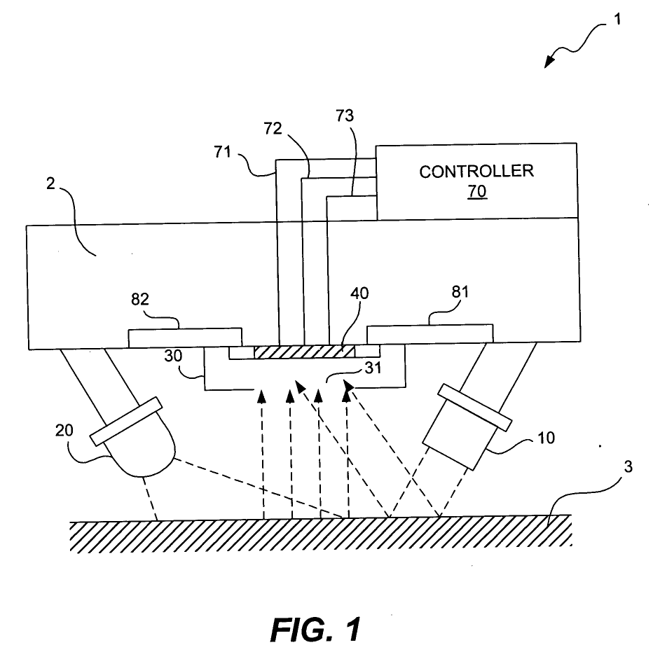

FIG. 1 illustrates a block diagram of the electrical and optical components of the optical navigation apparatus 1 of the invention in accordance with an exemplary embodiment. In accordance with the invention, the optical navigation apparatus 1 includes both a laser diode 10 light source and an LED 20 light source. When the laser diode 10 is being driven, the LED 20 is off. When the LED 20 is being driven, the laser diode 10 is off.

Preferably, the laser diode 10 is the default light source in that an attempt is first made to detect motion during a time period in which the laser diode 10 is being driven. If motion cannot be detected during this time period, the laser diode 10 is switched off and the LED 20 is driven. If motion cannot be detected while the LED 20 is being driven, then a determination is made that the navigation apparatus 1 is not in motion. The LED 20 is then switched off and the laser diode 10 is again driven and the algorithm restarts.

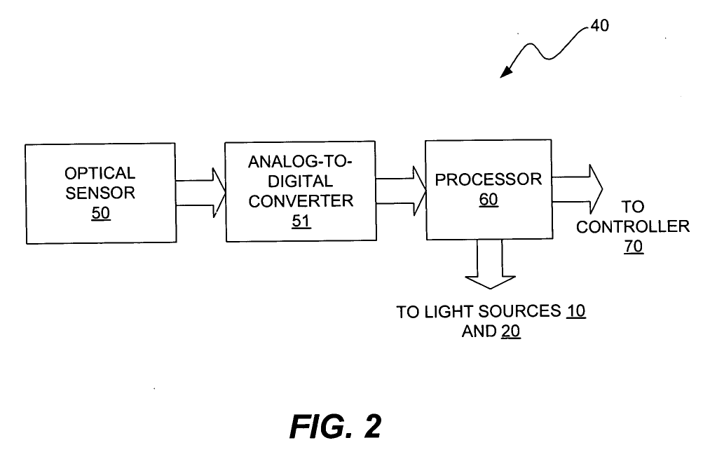

In the embodiment represented by the block diagram shown in FIG. 1, the electrical and optical components of the navigation apparatus 1 are mounted on a printed circuit board (PCB) 2. The apparatus 1 includes an integrated circuit (IC) package 30 that is mounted on the PCB 2. The IC package 30 has an opening 31 formed in it through which light reflected from a tracking surface 3 enters the package 30. The IC package 30 contains a navigation sensor IC 40 upon which light reflected from the tracking surface 3 impinges. The components of the IC 40 are shown in FIG. 2.

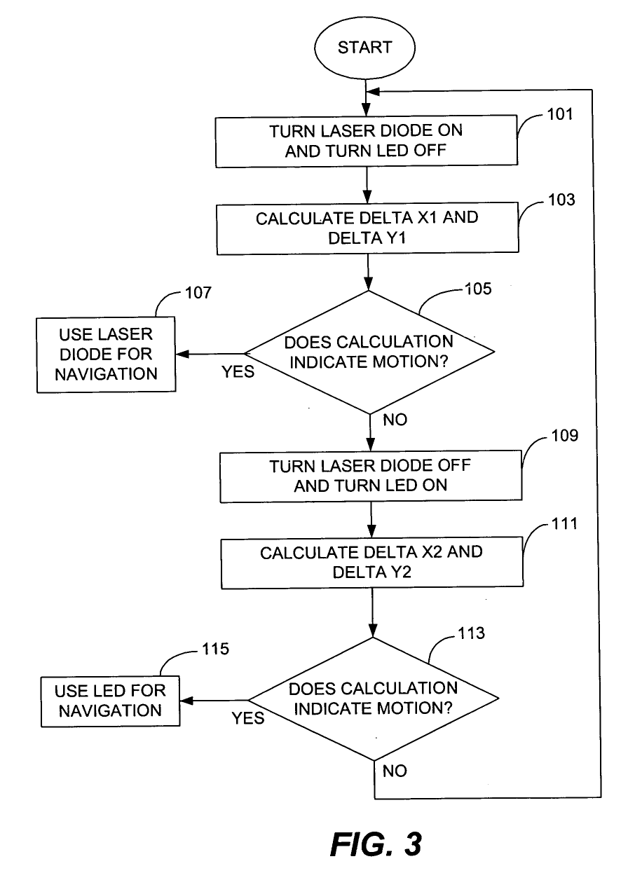

As shown in FIG. 2, the IC 40 includes an optical sensor 50 that converts the light that impinges on the IC 40 into electrical signals. The optical sensor typically includes one or more photodetectors. The IC 40 also includes analog-to-digital conversion (ADC) circuitry 51 and a processor 60. The processor 60 includes the logic for performing the algorithm of the invention, which is described below with reference to the flow chart illustrated in FIG. 3. The processor 60 receives the electrical signals from the ADC 51 and processes the signals to determine whether motion of the optical navigation apparatus 1 has occurred. Based on this determination, the processor 60 drives one or the other of the light sources 10 and 20, as described below in more detail with reference to FIG. 3. The processor 60 also generates motion reports based on the signals received from the ADC 51.

With reference again to FIG. 1, the optical navigation apparatus 1 includes a controller 70 that communicates with the IC 40 via lines 71, 72 and 73. The lines 71, 72 and 73 represent a 3-wire Serial Protocol Interface (SPI). Various types of SPIs exist, including 2-wire, 3-wire and 4-wire. In this exemplary embodiment, a 3-wire SPI is used. The controller 70 is mounted on the PCB 2. The controller 70 is typically an IC, such as an application specific integrated circuit (ASIC). The controller 70 receives motion reports from the IC 40 and processes the motion reports in accordance with a peripheral device protocol, such as, for example, the Universal Serial Bus (USB) Protocol, the Personal System/2 (PS/2) Protocol, etc., for communication over a bus (not shown) to the computer system (not shown) with which the optical navigation apparatus 1 is used.

The algorithm of the invention in accordance with an exemplary embodiment will now be described with reference to the flow chart illustrated in FIG. 3 and the block diagrams illustrated in FIGS. 1 and 1. The laser diode is turned on and the LED is turned off, as indicated by block 101 (FIG. 3). This is accomplished by simultaneously driving lines 81 and line 82 shown in FIG. 1 high and low, respectively. The processor 60 (FIG. 2) of the IC 40 calculates the change in the first set of X coordinates read, ΔX1, and the change in the first set of Y coordinates read, ΔY1, as indicated by block 103. Based on this calculation, the processor 60 determines whether or not the navigation apparatus 1 has moved, as indicated by block 105. Essentially, if the processor 60 calculates any change in either X1 or Y1, the processor 60 determines that it has detected motion. If the processor 60 calculates no change in either X1 or Y1, the processor 60 determines that there is no motion.

If a determination is made at block 105 that there is motion, then the laser diode continues to be driven and is used as the light source for navigation, as indicated by block 107. If a determination is made at block 105 that there is no motion, the laser diode is turned off and the LED is turned on, as indicated by block 109. This is accomplished by simultaneously driving lines 81 and line 82 shown in FIG. 1 low and high, respectively. The processor 60 (FIG. 2) of the IC 40 calculates the change in the second set of X coordinates read, ΔX2, and the change in the second set of Y coordinates read, ΔY1, as indicated by block 111. Based on this calculation, the processor 60 determines whether or not the navigation apparatus 1 has moved, as indicated by block 113. If the processor 60 detects motion, then the LED is used for navigation, as indicated by block 115. If the processor 60 does not detect any motion, then the laser diode is turned on and the LED is turned off, as indicated by the return of the process to block 101.

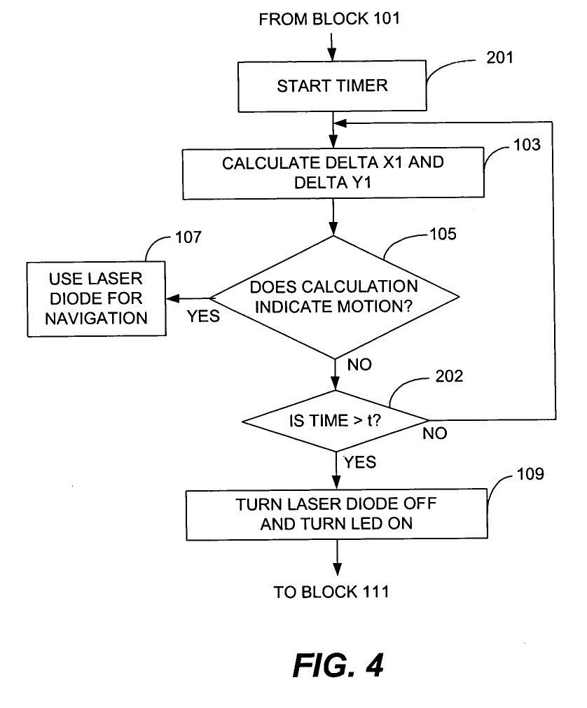

In accordance with the preferred embodiment, the determination made at block 105 in FIG. 3 is made during an evaluation that lasts for a time period of duration t. FIG. 4 illustrates a flowchart that is identical to the flowchart shown in FIG. 3 except that it includes blocks 201 and 202 that represent the functionality associated with evaluating the collected motion information over a time interval of duration t while the laser diode is on prior to turning off the laser diode and turning on the LED.

As shown in FIG. 4, after the laser diode is turned on (block 101 in FIG. 3), a timer is started, as indicated by block 201. The processor then calculates ΔX1 and ΔY1, as indicated by block 103. A determination is then made at block 105 as to whether the calculation indicates motion. If not, a determination is made as to whether the timer value is greater than t. If so, then the process proceeds to block 109 and continues in the manner described above with reference to FIG. 3. If a determination is made at block 202 that the timer value has not exceeded t, the process returns to block 103 and ΔX1 and ΔY1 are recalculated. The process continues passing through this loop until the time period of duration t is over or until motion has been detected. If a determination is made at block 105 that the calculation indicates motion, then the laser diode remains on and is used as the light source for navigation, as indicated by block 107.

Preferably, the laser diode light source is a VCSEL diode, although other laser diodes may also be suitable for use as the light source, such as, for example, various edge-emitting laser diodes. Many different types of LEDs are suitable for use as the LED light source.

Although FIG. 1 illustrates an apparatus in which the navigation sensor IC 40 and the controller IC 70 are separate ICs. It should be noted that the operations performed by both ICs may be achieved by a single IC, in which case the single IC would include logic for performing motion detection and reporting as well as I/O interface protocol logic, such as, for example, USB or PS/2 interface protocol logic.

It should be noted that the invention has been described with reference to exemplary embodiments and that the invention is not limited to these embodiments. Modifications may be made to the embodiments described herein and all such modifications are within the scope of the invention.

What is claimed is:

1. An optical navigation apparatus comprising:
a first light source;
a second light source;
an optical sensor that converts light into electrical signals; and
processing logic configured to process the electrical signals to obtain information relating to motion or an absence of motion of the optical navigation apparatus and to turn on and off the first and second light sources based on the information relating to motion or an absence of motion of the optical navigation apparatus.

2. The optical navigation apparatus of claim 1, wherein if during a time period when the first light source is turned on and the second light source is turned off, said information indicates an absence of motion of the optical navigation apparatus, the processing logic turns off the first light source and turns on the second light source.

3. The optical navigation apparatus of claim 2, wherein when the first light source is turned off and the second light source is turned on and said information indicates an absence of motion of the optical navigation apparatus, the processing logic turns off the second light source and turns on the first light source.

4. The optical navigation apparatus of claim 1, wherein the first light source is a laser diode and the second light source is a light emitting diode (LED).

5. The optical navigation apparatus of claim 4, wherein the laser diode is a vertical cavity surface-emitting laser (VCSEL) diode.

6. The optical navigation apparatus of claim 4, wherein the laser diode is an edge-emitting laser diode.

7. The optical navigation apparatus of claim 1, wherein the optical sensor and the processing logic are integrated together in an integrated circuit (IC).

8. The optical navigation apparatus of claim 1, wherein the processing logic includes logic configured to process the electrical signals to generate motion reports.

9. The optical navigation apparatus of claim 8, further comprising:
a controller that receives the motion reports generated by the processing logic and converts the motion reports into signals that conform to a peripheral device protocol for transmission over an input/output (I/O) bus that conforms to the peripheral device protocol to a computer system with which the optical navigation apparatus is used.

10. The optical navigation apparatus of claim 9, wherein the processing logic is part of a first integrated circuit (IC) that includes the optical sensor, and wherein the controller is part of a second IC, the first and second ICs being electrically connected to each other by one or more conductive signal lines.

11. The optical navigation apparatus of claim 9, wherein the processing logic, the optical sensor and the controller are integrated together on a single integrated circuit (IC), the IC including logic for formatting the motion reports in accordance with a peripheral device protocol.

12. A method for performing optical navigation in an optical navigation apparatus, the method comprising:
turning on a first light source;
determining whether or not any motion of the optical navigation apparatus has been detected by an optical sensor of the optical navigation apparatus; and
if a determination is made that no motion has been detected, turning off the first light source and turning on a second light source.

13. The method of claim 12, further comprising:
after turning off the first light source and turning on the second light source, making a second determination as to whether or not any motion of the optical navigation apparatus has been detected by the optical sensor; and
if the second determination is that motion has not been detected, turning off the second light source and turning on the first light source.

14. The method of claim 13, wherein the first light source is a laser diode and the second light source is a light emitting diode (LED).

15. The method of claim 14, wherein the laser diode is a vertical cavity surface-emitting laser (VCSEL) diode.

16. The method of claim 14, wherein the laser diode is an edge-emitting laser diode.

17. The optical navigation apparatus of claim 12, wherein the method is performed by logic in an integrated circuit (IC).

18. The method of claim 12, further comprising:
generating motion reports based on the determinations.

19. The method of claim 18, further comprising:
converting the motion reports into data signals that conform to a peripheral device protocol.

20. A computer program for performing optical navigation in an optical navigation apparatus, the program being embodied on a computer-readable medium, the program comprising:
a first code segment for turning on a first light source;
a second code segment for determining whether or not any motion of the optical navigation apparatus has been detected by an optical sensor of the optical navigation apparatus; and
a third code segment for turning off the first light source and turning on a second light source if a determination is made by the second code segment that no motion has been detected.
